(19) United States
(12) Patent Application Publication
(10) Pub. No.: US 2009/0326685 A1
(43) Pub. Date: Dec. 31, 2009

(54) MOBILE PROGRAMMABLE CONTROL DEVICE

(76) Inventors: Josef Meixner, Erlangen (DE); Andreas Schertl, Vilseck (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/490,506

(22) Filed: Jun. 24, 2009

(30) Foreign Application Priority Data
Jun. 25, 2008 (DE) 10 2008 030 085.3

(51) Int. Cl. G05B 15/00; H04Q 5/22

(52) U.S. Cl. 700/83; 340/10.1

(57) ABSTRACT

Mobile programmable control device which functionally combines within itself the traditional tasks of a programmable logic controller (PLC) and an active RFID transponder (tag), or, as the case may be, which integrates a PLC and an active RFID transponder in hardware and software terms. The application program for the control device, i.e. including PLC and RFID tag, can be produced using a programming environment conforming to IEC 61131. For that purpose the microcontroller of the RFID tag requires a corresponding runtime environment. The application programs in the control device can thus be executed cyclically and in synchronism with the PLC. By virtue of its small and compact design the control device can be physically attached to mobile objects of a technological process for the purpose of the latter's automation, control or tracking/documentation. Mobile objects also represent process objects in the technological process both physically and in information technology terms.

### CROSS REFERENCE TO RELATED APPLICATIONS

This application claims priority of German application No. 10 2008 030 085.3 filed Jun. 25, 2008, which is incorporated by reference herein in its entirety.

### FIELD OF INVENTION

The invention relates to mobile programmable control devices, a programming device for programming said control devices, and a system comprising a mobile programmable control device and a sensor.

### BACKGROUND OF INVENTION

A multiplicity of components, such as e.g. drives, sensors, final control elements, programmable logic controllers (PLCs), are deployed for the purpose of automating and controlling technological processes in the industrial environment (e.g. printed circuit board fabrication, baggage handling system control, automobile production). RFID readers and RFID tags (transponders) are also used in the field of automation engineering, however.

### SUMMARY OF INVENTION

The international patent application WO 2007/059184 A2 discloses the integrative coupling of RFID tag data with programmable logic controllers (PLCs).

Patent specification U.S. Pat. No. 7,339,476 B2 discloses systems and methods for integrating RFID technology with industrial controllers.

The integration of programmable logic controllers (PLCs) with RFID transponders for the purpose of controlling technological processes is not yet optimal, however.

The object of the present invention is to provide a mobile programmable control device and a matching programming device which provide an improved integration of programmable logic controllers (PLCs) and RFID transponders.

This object is achieved by means of a mobile programmable control device which functionally combines within itself the traditional tasks of a programmable logic controller and an RFID transponder, the control device comprising:

a voltage supply by means of battery, rechargeable battery or power pack;

an interface for inputting and/or outputting data;

means for loading application programs from a programming device or engineering system;

a processor, an operating system and a runtime system for executing application programs;

an RFID transponder for receiving and transmitting radio signals, the RFID transponder being operatively connected to the processor, the operating system and the runtime system for the purpose of executing the application programs, the application programs containing instructions for processing functions of a programmable logic controller and simultaneously instructions for processing functionality of the RFID transponder. The control device according to the invention thus combines the characteristics of a programmable logic controller (PLC) and an active RFID transponder (tag) in one device.

The programming and configuration means for programmable logic controllers can therefore be used also for programming the RFID transponders. Personnel familiar with the underlying technical process and with the programming of programmable logic controllers can therefore be deployed also for programming the RFID transponders, without having to be familiar with the software-oriented programming paradigms for RFID transponders which are customarily to be employed. An additional software developer for programming the RFID transponder is consequently not required. Automating a technical process can therefore be carried out by a person with knowledge of PLC programming and tools. Furthermore, a common runtime system is sufficient in the control device in order to process the functionalities of PLC and RFID transponder. This is advantageous for the manufacture, configuration, shipment and maintenance of the control device. The mobile control device is easy to handle and to attach to stationary or also to mobile objects (e.g. driverless transportation system, conveying containers, tools), thereby enabling said mobile objects to be furnished with their own dedicated processing intelligence and their own processing status (data). The control device according to the invention thus offers the hardware- and software-oriented combination of the characteristics of a PLC and an active RFID tag.

A first advantageous embodiment of the present invention consists in the application program being produced using a development environment that is suitable for the programming of programmable logic controllers. Application programs for RFID transponders are typically programmed in a conventional microcontroller development environment, corresponding to the microcontroller on the transponder. If the microcontroller on the transponder is equipped with a corresponding runtime environment, means for programming programmable logic controllers, such as function block diagram, instruction list, ladder diagram etc., can be used for programming the chip on the active RFID transponder. PLC programmers familiar with the technological processes can thus also carry out the programming of the active RFID transponders. Accordingly, programming of the control device is accomplished from a “single source” and using one tool.

A further advantageous embodiment of the present invention consists in the data input and/or output interface being connected to sensors and/or actuators and/or keys and/or LEDs and/or a display for the purpose of communicating with the technological process or with an operator working therein and said technological process is managed and/or controlled by means of the input and/or output of the data. The control device according to the invention thus possesses the functionality of a programmable logic controller and consequently can replace a “pure” PLC. This results in advantages for manufacture (economies of scale). The battery and the radio link permit a wider and more flexible range of application than in the case of “pure stationary” PLCs.

A further advantageous embodiment of the present invention consists in the RFID transponder being operatively connected via the data input and/or output interface to sensors and/or actuators and/or keys and/or LEDs and/or displays of a technological process and/or its operators. Simple RFID transponders do not possess the capability of connecting actuators or sensors for the purpose of controlling technical processes. By integrating RFID transponders into the control device according to the invention it is also possible for actuators or sensors or simple HMI elements to be connected by means of the integrated transponder or, as the case may be, to be addressed and taken into account via the application programs. This can be realized either wirelessly (e.g. via radio, infrared) or via a fixed wiring arrangement.

Example: In the baggage handling system of an airport it is possible, by means of the method presented, for a suitcase to remember whether it has already been “X-rayed”. It receives this information via a reader/writer when passing through the X-ray system and indicates this by, say, a green LED or a number on the suitcase/control device. However, it may be a requirement of the operational processes that this status can be cleared again locally by the handling personnel. This can be implemented by means of a key on the control device/suitcase. Such or similar logics (e.g. for dealing with different priorities for suitcases) can be programmed and processed in the control device according to the invention.

A further advantageous embodiment of the present invention consists in the application programs being processed cyclically as in the case of a PLC. The control device therefore not only enables the full substitution of the mode of operation of a programmable logic controller, but also offers a better integration and expansion of the mode of operation of the RFID transponder, in which application programs are usually executed after being triggered by events or, as the case may be, by being “freely” programmed.

The object is also achieved by means of a mobile programmable control device, in particular for controlling a technological process, the control device comprising:

a programmable logic controller; and

an RFID transponder with integrated microcontroller, the programmable logic controller and the RFID transponder operatively interacting for the purpose of controlling the technological process, and the mobile programmable control device functionally combining within itself the traditional tasks of a programmable logic controller and of an RFID transponder, a common application program being provided for the programmable logic controller and the microcontroller of the RFID transponder, and the application program being cyclically executable. The mobile control device possesses the same runtime environment as a PLC and is therefore able to execute application programs in accordance with a standardized PLC language (IEC 61131). That is to say that the application program is also cyclically processed on the control device and adapts to the cycle of the integrated PLC. The cycles of control device and integrated PLC thus run in synchronism and possess exactly the same cycle time. Because the application program for the control device according to the invention can be produced using a PLC language, no additional software developer is required for programming the microprocessor of the RFID transponder. The control device according to the invention provides the hardware- and software-related combination of the characteristics of a PLC and an active RFID transponder.

A further advantageous embodiment of the present invention consists in the application program being produced using a development environment that is suitable for programming programmable logic controllers. No additional programming or development environment is therefore required for programming the application program of the RFID transponder. The PLC and the RFID transponder of the control device can be programmed using one programming or development environment. This facilitates the development of application programs in the field of technological process automation.

A further advantageous embodiment of the present invention consists in the RFID transponder being able to be operatively coupled to sensors and/or actuators of the technological process via an input/output unit of the programmable logic controller. RFID transponders usually do not possess the capability of connecting actuators or sensors for controlling technical processes. By integrating RFID transponders into the control device according to the invention it is also possible to connect or, as the case may be, address actuators or sensors by means of the integrated RFID transponder. This can be realized either wirelessly (e.g. via radio, infrared) or via a fixed wiring arrangement.

A further advantageous embodiment of the present invention consists in the control device being fixable to a mobile object, and in the mobile object being thereby trained to act as an active object within the meaning of the object-oriented paradigm. The mobile control device possesses a robust and compact design and is thereby easily attachable to objects, in particular mobile objects (e.g. by means of screwed, plug-in or adhesive connections). This enables mobile objects (e.g. pieces of luggage, containers, driverless transportation systems) to be furnished with a local intelligence (microprocessor of the RFID transponder). The mobile objects can therefore be assigned status and behavioral information which can be interrogated during operation. Based on the chosen type of connection, control device and mobile object can be connected to each other permanently, temporarily or as a function of operational requirements. This means that e.g. a large number (e.g. 10,000) of circulating containers can also be represented by a relatively small number of mobile control devices (e.g. 100) which are attached to a container when the container is received in its own operational zone and removed again when it leaves the operational zone.

A further advantageous embodiment of the present invention consists in dedicated application program cycles being provided in each case for connecting the control device to an object and for separating the control device from the object. The control device according to the invention can be temporarily physically connected to an object, e.g. a mobile object (e.g. by means of screwed, plug-in or adhesive connections). The controlled and defined attachment and removal of the control device to and from the object and the response thereto defined by the programmer can be ensured by means of dedicated application program routines or application program cycles which are executed during the connecting or separating.

The object is further achieved by means of a programming device for the control device according to the invention, the programming device comprising:

input means for inputting user commands for application programs for the control device;

output means for representing edited application programs and process data of individual or interconnected control devices;

programming software executing on a processor of the programming device for the purpose of converting the input user commands for the production of the application programs, the produced application program simultaneously including instructions for processing functions of a programmable logic controller and for processing functionality of a microprocessor of an RFID transponder. The programming device enables the development of application programs for the control device which can be executed both by the PLC and by the microprocessor of the RFID transponder. Accordingly, only one programming tool is necessary. Furthermore, the use of just one means for programming the data continuity between PLC and RFID transponder and the data continuity and process integration of the control device according to the invention with other established automation devices is very easily ensured.

A further advantageous embodiment of the present invention consists in the application programs being written in a standardized language, in particular a language conforming to IEC 61131, for programmable logic controllers. Programming tools for programmable logic controllers that support the international standard IEC 61131 are widely available and are offered by many manufacturers. Thus, the developer is not limited to or reliant on proprietary programming tools when programming the control device according to the invention.

A further advantageous embodiment of the present invention consists in the application programs being implementable as a ladder diagram, as a function block diagram, as an instruction list, as a runtime language, as structured text or as a sequential function chart. Many automation specialists are skilled in the IEC 61131-compliant programming languages or means. No costly additional training courses are therefore necessary for programming the control device according to the invention. The microprocessor of the RFID tag can also be programmed in accordance with IEC 61131 and requires no extra programming environment that supports other additional software engineering concepts.

The object is further achieved by means of a system comprising the mobile control device according to the invention and a sensor for determining whether the control device is disposed on a (mobile or stationary) object or whether it is “alone”. If the sensor detects that the mobile control device is no longer disposed on the object, the application program cycle for orderly and defined removal of the control device is started automatically. Thus, even after removal from the object, the control device is also in a defined status that is specifiable by the programmer. If the sensor detects that the mobile control device is (once again) located on the object, the application program cycle for orderly and defined connection of the control device is started automatically. Thus, even after connection to the object, the control device is also in a defined status that is specifiable by the programmer.

### BRIEF DESCRIPTION OF THE DRAWINGS

An exemplary embodiment of the invention is illustrated in the drawing and explained below.

Brief description of the figures:

FIG. 1 shows a schematic overview diagram of an RFID system coupled to a data processing system,

FIG. 2 shows a schematic representation of the mobile, programmable control device according to the invention, and

FIG. 3 shows an exemplary embodiment of the use of the control device according to the invention in a technological process.

### DETAILED DESCRIPTION OF INVENTION

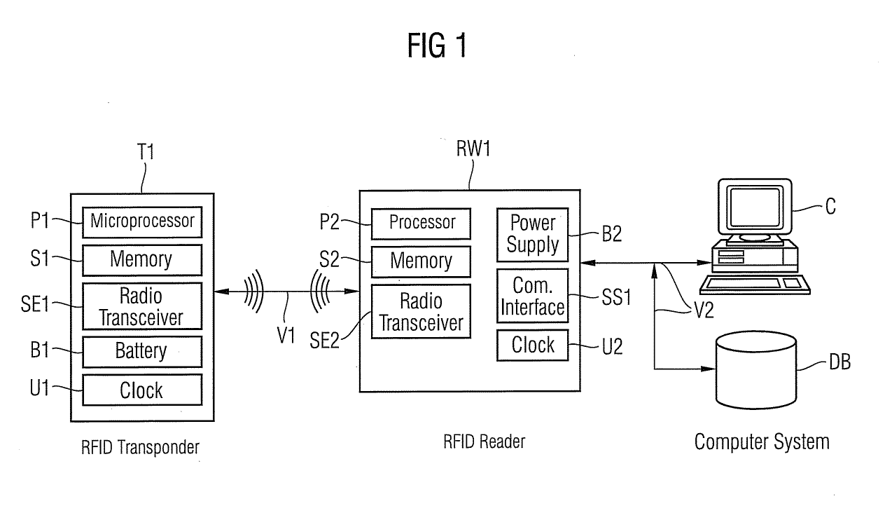

FIG. 1 shows a schematic overview diagram of an RFID system coupled to a data processing system. The RFID system shown in FIG. 1 consists of an RFID transponder (tag) T1 having a microprocessor P1, a memory S1, a transceiver unit SE1, a battery B1 and a clock U1, and of an RFID reader RW1 having a processor P2, a memory S2, a transceiver unit SE2, a battery or voltage supply B2, a communications interface SS1 and a clock U2 (real-time clock). The RFID reader RW1 communicates with the RFID transponder T1 via the radio link V1. The RFID reader RW1 communicates with the computer system, consisting of a computer C and a database DB, via the communications interface SS1 and the link V2. According to the prior art, the computer C and the database DB can also be a conventional PLC with connected SCADA, process data or MES (Manufacturing Execution System) system. The RFID transponder T1 is embodied as an active transponder, which is to say it possesses a processing unit P1 and an autonomous power supply B1 as well as a clock U1. The application programs for the RFID transponder T1 and the RFID reader RW1 are programmed in a conventional microcontroller development environment. RFID systems are increasingly being deployed for controlling technological processes alongside the traditional automation components such as programmable logic controllers.

The radio link V1 between the RFID transponder T1 and the RFID reader RW1 is implemented via antennas on both sides. The microprocessor P1 of the transponder T1 can be embodied as complex and have a von Neumann architecture. RFID transponders T1 of this type are typically small in terms of their design format, adapted to the application conditions and implemented as power-saving. They can also be used for demanding automation tasks.

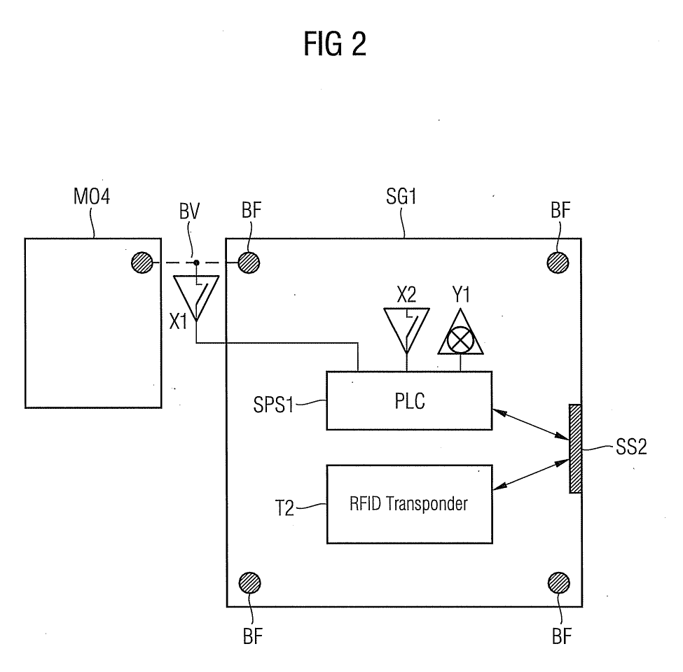

FIG. 2 shows a schematic representation of the mobile programmable control device SG1 according to the invention. RFID transponders T1, T2 are mostly used for identifying and tracking goods, but increasingly they can also be used as a platform for runtime environments, for executing application programs, in particular when a corresponding microprocessor P1 is present. Automation components such as programmable logic controllers or RFID systems have been programmed separately hitherto. A programmable logic controller SPS1 is programmed in accordance with a standardized PLC language, an active RFID transponder with a traditional programming language, depending on the microcontroller installed in the RFID transponder T2. Associated therewith are different runtime environments for executing the respective application programs. Whereas the application program is processed cyclically on a programmable logic controller, on an active RFID transponder, by contrast, it is executed freely, that is to say triggered by events. The disadvantage of this approach is clear: Knowledge of different programming paradigms is required, as well as the definition of an interface in order to ensure the communication between programmable logic controller and active RFID transponder. Consequently it is very difficult to well nigh impossible to have the automation of a technological process of this type carried out by a single individual. This would inevitably lead to many reworking measures such as e.g. project-specific interfaces etc. Furthermore, different tools are required for the programming, which entails a lack of data continuity. Separate programming therefore creates a substantial amount of additional overhead.

In order to solve the problems described it is proposed to combine the characteristics of a programmable logic controller SPS1 and an active RFID transponder T2 in a mobile programmable device SG1. In concrete terms this means that both the PLC and the RFID transponder can be programmed using a standardized PLC language and therefore also possess the same runtime environment for executing application programs.

A programmable logic controller is characterized by the following properties:

cycle-oriented, i.e. the application program is processed cyclically,

programmable in accordance with a standardized language, typically IEC 61131,

hard-wired and installed in the switching cabinet,

inputs and outputs.

Active RFID transponders are characterized by the following properties:

radio-based,

programmable dependent on the microcontroller provided,

mobile,

robust and small design.

Uniting these features to create a mobile programmable control device SG1 provides the following advantageous attributes and properties:

cycle-oriented, i.e. the application program is processed cyclically,

programmable in accordance with a standardized language, typically IEC 61131,

radio-based,

mobile and movable,

robust and small design,

possible connection options for radio-based or hard-wired inputs and outputs.

The software- and hardware-related combination of the properties of a programmable logic controller SPS1 and an active RFID transponder T2 thus provides the following advantages:

Knowledge of different programming environments is no longer necessary for programming the control device SG1. Both devices can therefore be programmed by the same person. Both the programmable logic controller SPS1 and the RFID transponder T2, in other words, therefore, the control device SG1, are programmed using a standardized PLC language, typically IEC 61131 (function block diagram, instruction list, ladder diagram, structured text). The IEC 61131 standard is concerned with the basics of programmable logic controllers (PLCs), the third part of said standard defining the five programming languages with which a programmable logic controller can be programmed: instruction list, ladder diagram, function block language, runtime language and structured text.

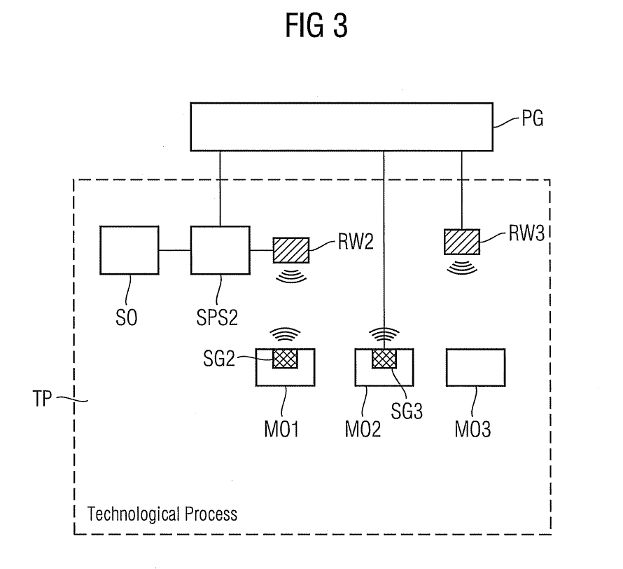

A further advantage resides in the fact that the same development environment PG (FIG. 3) as used for programming a programmable logic controller can be used for producing the application programs for the control device SG1. The mobile control device SG1 possesses the same runtime environment as a programmable logic controller SPS1 and is therefore able to execute application programs conforming to a standardized PLC language. The microprocessor of the RFID transponder T2 also possesses a runtime environment for executing application programs written in a standardized PLC language. In other words, the application program is also processed cyclically on the control device SG1 and adapts to the cycle of the programmable logic controller SPS1. The cycles of the programmable logic controller SPS1 and the mobile control device SG1 therefore run in synchronism and consequently possess exactly the same cycle time. In concrete terms this means that as in the case of a programmable logic controller the process image of all the inputs SS2 connected to the mobile control device SG1 is updated first, then the application program is executed and finally the process image resulting therefrom is transferred to the outputs of the control device SG1.

In contrast to “standalone” RFID transponders, the control device SG1 according to the invention offers the possibility of connecting actuators and/or sensors. This can be implemented either via radio link or via a hard-wired arrangement. In the case of a hard-wired arrangement the sensors X1, X2 and actuators (or indicators) Y1 must be located on the carrier of the mobile control device SG1 (in the case of an electrical plug-in connection between a mobile object MO4 and the control device SG, they can also be mounted on the mobile object MO4).

The mobile control device SG1 can be connected via the interface SS2 to an RFID reader; a connection of this kind is usually realized via radio link. The mobile control device SG1 can also be connected to a computer system and to a database via the interface SS2. A connection of this kind can be realized via cable, as a USB connection for example, but also wirelessly (radio, infrared, Bluetooth etc.).

With the aid of the fixing means BF, the mobile control device SG1 can be attached physically either permanently or temporarily to objects, in particular mobile, but also stationary objects, in a technological process, for example by means of adhesive, plug-in or screwed connections BV, which can also be additionally embodied electrically for the purpose of the voltage supply or for sensors or actuators. A mobile object in a technological process (e.g. piece of luggage, driverless transportation system, container) can thus be equipped with a dedicated intelligence. A mobile control device SG1 trained in this way represents a mobile process object that also corresponds to an object with encapsulated status and behavior according to the object-oriented paradigms.

The sensors X1, X2 can be located directly at the or on a mobile control device SG1. The sensor X1 can be used e.g. for detecting a connection BV, the sensor X2 e.g. for determining the position of the control device SG1. The connection BV is a permanent or temporary mechanical or mechanical-electrical connection between the control device SG1 and the mobile object MO4. A connection BV is established via one or more fixing means BF. Actuators Y1 and/or pushbuttons and/or indicators can also be located on the mobile control device SG1.

The mobile control device SG1 can therefore be attached temporarily to a mobile object in a technological process. With the aid of a special sensor X1 it is possible to detect whether a mobile control device SG1 is physically located on a mobile object (e.g. piece of luggage, suitcase etc.). In this way the current status of the control device SG1 can be permanently detected. The position of the control device/object in space can also be detected via a further special sensor. Two special application program cycles are provided for the purpose of attaching and removing the mobile control device to and from an object. This ensures that the object is in a defined state as a process object when the control device SG1 is attached and removed. The defined removal of the mobile control device SG1 from mobile objects is beneficial because the mobile objects may be subject to wear and tear or turnover or can occur in infinite number in the process (e.g. suitcases) and the control devices SG1 can and must be either replaced or fixed to a new object.

FIG. 3 shows an exemplary embodiment of the use of the control device SG2 to SG3 according to the invention in a technological process. The mobile control devices SG2 to SG3 are attached to the mobile objects MO1 to MO2, in each case by means of a screwed, plug-in or adhesive connection. In the example the object MO3 possesses no dedicated control device of its own. The mobile objects MO1 to MO3 (e.g. containers or pieces of luggage) are part of an automated technological process TP. A mobile control device SG2 to SG3 is usually connected temporarily to a mobile object MO1-MO3. In baggage handling at the airport, for example, it makes little sense for a mobile control device SG2 to SG3 to be located on a piece of luggage MO1-MO3 after the latter has been collected by a traveler. The illustration according to FIG. 3 shows a common programming environment PG for programming the conventional programmable logic controller SPS2 and the application program for the RFID read/write unit RW3, as well as the control devices SG2 to SG3 connected via RFID read/write units RW2 or RW3, or permanently connected in the configuration case. The RFID read/write unit RW2 permanently installed with the programmable logic controller SPS2 can also be programmed by means of the programming device PG. In FIG. 3, the conventional and stationary programmable logic controller SPS2 is permanently connected via sensors and actuators to a stationary object SO (e.g. gate of a conveyor belt). The RFID read/write unit RW3 is usually also permanently installed in the technological process TP for the latter's automation. By virtue of their design the mobile control devices SG2 to SG3 are small, power-saving and mobile, and can therefore be flexibly deployed in a technological process TP, particularly on mobile objects MO1 to MO3, such as, for example, containers, driverless transportation systems, pieces of luggage. The mobile control devices SG2 to SG3 possess an intelligence and therefore represent mobile process objects. As a result of the programming from a single programming device the intelligence of SG2 to SG3 is coordinated with the intelligence of SPS2. The intelligence of the control devices SG2 to SG3 also includes a memory unit (Memory), which can contain, for example, the next incremental steps or information concerning the processing status of the represented mobile object, etc.

In order to perform, that is to say automate, the technological process TP, different processing or handling steps are necessary, for the automation of which a multiplicity of components are employed, such as, for example, drives, programmable logic controllers, sensors, RFID transponders, RFID readers, etc. Many advantages for the automation of technological processes TP are produced as a result of bundling and combining programmable logic controllers, or, as the case may be, the functionality of programmable logic controllers, with RFID transponders in a common mobile control device SG1 to SG3. Thus, a common and coordinated configuration with application program for the control device SG2 to SG3 and SPS2 but also e.g. for drives included in the process can be produced by means of a common development environment PG, which application program can be executed by the microprocessor of the RFID transponder and by a PLC. Furthermore, mobile objects MO1 to MO3 (such as, for example, a piece of luggage), which are otherwise passive in information technology terms from the software engineering viewpoint, can be very easily and elegantly furnished with intelligence by the physical attachment of a control device SG1 to SG4 and said mobile objects MO1 to MO3 can represent real process objects. In this case the intelligence can be used further in the form of a finite number of devices for an infinite number of mobile objects.

Mobile programmable control device which functionally combines within itself the traditional tasks of a programmable logic controller (PLC) and an active RFID transponder (tag), or, as the case may be, which integrates a programmable logic controller (PLC) and an active RFID transponder in hardware and software terms. The application program for the control device, i.e. including PLC and RFID tag, can be written using a programming environment conforming to IEC 61131 (ladder diagram, FBD, instruction list, structured text, etc.). For that purpose the microcontroller of the RFID tag requires a corresponding runtime environment. The application programs in the control device can thus be executed cyclically and in synchronism with the PLC. By virtue of its small and compact design the control device can be physically attached to mobile objects of a technological process for the purpose of the latter's automation, control or tracking/documentation. By this means it is possible for said mobile objects also to represent process objects in the technological process both physically and in information technology terms.

1.-14. (canceled)

15. A mobile programmable control device which functionally combines within itself the traditional tasks of a programmable logic controller and an RFID transponder, the mobile programmable control device comprising:
a voltage supply;
a data input and/or output interface;
an application program loaded from a programming device or an engineering system and containing instructions which when executed processes functions of the programmable logic controller and processes functionality of the RFID transponder;
a processor,
an operating system;
a runtime system; and
an RFID transponder that receives and transmits radio signals, the RFID transponder is operatively connected to the processor, the operating system and the runtime system in order to execute the application program.

16. The control device as claimed in claim 1, wherein the application program is produced using a development environment that is suitable for programming the programmable logic controller.

17. The control device as claimed in claim 1, wherein the data input and/or output interface is connected to at least one device selected from the group consisting of sensor, actuator, key, LED, and a display, thereby communicating with a technological process or with an operator working therein and the technological process is controlled via the input and/or output of the data.

18. The control device as claimed in claim 1, wherein the RFID transponder is operatively connected via the data input and/or output interface to at least one device selected from the group consisting of sensor, actuator, key, LED, and a display of a technological process and/or its operators.

19. The control device as claimed in claim 1, wherein the application program is processed cyclically.

20. A mobile programmable control device for controlling a technological process, the control device, comprising:
a programmable logic controller; and
an RFID transponder with an integrated microcontroller; and
a common application program executing cyclically and having instructions for the programmable logic controller and the integrated microcontroller of the RFID transponder,
wherein the programmable logic controller and the RFID transponder operatively interact thereby controlling the technological process;
whereby the mobile programmable control device functionally combines within itself the traditional tasks of a programmable logic controller and an RFID transponder.

21. The control device as claimed in claim 20, wherein the common application program is produced using a development environment that is suitable for the programming and/or configuration of the programmable logic controller.

22. The control device as claimed in claim 20, wherein the RFID transponder is operatively coupled to sensors and/or actuators of the technological process via an input/output unit of the programmable logic controller.

23. The control device as claimed in claim 20,
wherein the control device is attachable to a mobile object, and
wherein the mobile object thereby acts as an active object within the meaning of the object-oriented paradigm.

24. The control device as claimed in claim 20, wherein dedicated application program cycles are provided in each case for connecting the control device to an object and for separating the control device from the object.

25. A system comprising a mobile control device as claimed 20, comprising a sensor that determines when the control device is located on an object.

26. A programming device for a mobile programmable control device functionally that combines within itself the traditional tasks of a programmable logic controller and an RFID transponder, the programming device comprising:
a processor;
user commands for an application program to be executed the control device;
a display device that displays an edited application program and process data of individual or interconnected control devices; and
programming software executing on the processor and which converts the user commands into the application program such that the application program simultaneously includes instructions for processing functions of the programmable logic controller and for processing functionality of a microprocessor of the RFID transponder.

27. The programming device as claimed in claim 26, wherein the application program is written in a standardized language for programmable logic controllers

28. The programming device as claimed in claim 27, wherein the application program is written in a language conforming to IEC 61131.

29. The programming device as claimed in claim 26, wherein the application program is implemented as a ladder diagram, as a function block diagram, as an instruction list, as a runtime language, as structured text or as a sequential function chart.
